(19) United States
(12) Patent Application Publication
(10) Pub. No.: US 2009/0292608 A1
(43) Pub. Date: Nov. 26, 2009

(54) Method and system for user interaction with advertisements sharing, rating of and interacting with online advertisements

(76) Inventor: Ruth Polachek, Rehovot (IL)

Correspondence Address: RICHARD B. KLAR, 145 WILLIS AVENUE, SUITE NO. 6, MINEOLA, NY, 11501, US

(21) Appl. No.: 12/454,620

(22) Filed: May 20, 2009

Related U.S. Application Data
(60) Provisional application No. 61/128,573, filed on May 22, 2008.
(60) Provisional application No. 61/131,185, filed on Jun. 6, 2008.

(51) Int. Cl. G06Q 30/00; G06F 15/16; G06F 3/048; G06Q 10/00

(52) U.S. Cl. 705/14.44; 709/206; 715/780; 715/810

(57) ABSTRACT

A platform includes an overall system for user interaction, associated with a particular advertisement. The process enables users to interact with a widget directly associated with an advertisement and express themselves in regards to the advertisement. Advertisement displayed in the Internet or similar distributed computer network-based information distribution system. Such user interactions include engagement methods such as rating advertisements, sharing them with other users, commenting on them, and more. The platform can also include a host site, storing and processing data received by users. As well as means for targeting advertisements and serving them to users according to data collected through the platform directly inserted by the users or collected by the platform in regards to their interaction with the platform.

### RELATED APPLICATIONS

This is a non-provisional application of provisional application Ser. No. 61/128573 by Ruth Polachek filed on May 22, 2008 and provisional application Ser. No. 61/131185 by Ruth Polachek filed Jun. 6, 2008.

### BACKGROUND OF THE INVENTION

1. Field of the Invention

This invention relates to the field of electronic advertising as well as to the field of user engagement with electronic media. In particular, the present invention provides for such engagements including but not limited to rating, sharing, commenting, and other user feedback and methods of interaction with content. This system and method of the present invention can occur on a network of computers (such as the Internet), mobile devices or by any other electronic means.

2. The Related Art

Websites on the internet include advertisements along with other content to users. While in the past users were exposed to advertisements which were not necessarily relevant to their interests and needs, these days advertisers focus their actions in efforts to maximize relevancy of their advertisements to the targeted users.

Advertisers aim to optimize their campaigns' results by reaching the most relevant audience for their advertisement. A major problem that online content and advertisement publishers face online is how to maximize user relevancy in the exposure of their online advertisements (reaching qualified users, not random ones).

The current situation of targeting campaigns to the relevant users includes various methods. These methods include results from online campaigns by Click-Through Rates (“CTRs”—common metric for recording advertisement results) for a given campaign. Additional method is online targeting methods including behavioral targeting, which tracks users' online behavior such as which websites they visit in order to infer what their advertisement preferences are. They also include focus groups, which can provide data regarding the potential clients' receptiveness to advertisements.

The solutions faced by the advertisers provide limited information only. They do not provide the advertising party, e.g. the publisher or the advertiser, with comprehensive knowledge of the perspective user. In measuring Click-Through Rates, the advertisers do not gain knowledge as to those users who strongly object to their brand or advertisement. They also are not necessarily capable of knowing why (and whether) their users have developed strong negative views about their advertisement or product. The online targeting which does not take into account the user's direct and willful participation may also create negative results and false information, especially as users become increasingly aware of their privacy considerations. The historical data as to users' previous actions often can be misleading regarding the user's true preferences. A focus group, on the other hand, is limited in its scope, is typically expensive and cannot always provide a representative mix of the potential consumers.

The following is a recent large trend on the Internet. Users of online websites have become more and more involved over the past few years with user generated content and empowerment of users on the web in general, and specifically in online communities of users.

Existing online communities where users interact with content include, among others, rating websites such as Digg.com; online communities and social networks such as Facebook.com, MySpace.com; blogs such as on Blogger.com, WordPress.com.

This has also been done through various online services, which include, among others, various content rating systems, as well as content sharing platforms. Users like to express their opinions, and they, at times, gain considerable benefit from doing so. Until these services became prevalent, content was mainly written by professionals, and users did not have places to express their views publicly.

A major problem that online communities are faced with is how to benefit from and leverage their network of contacts (as in an online community) in order to monetize them and profit from their large user base. Users would like to express their opinions, specifically to the advertisers themselves, regarding their advertisements. This is true especially regarding negative opinions, but there are other concerns as well. A great number of users are annoyed with many of the existing advertisements they encounter in the numerous websites. They often lack a place where they could direct their opinions pertaining to specific advertisements directly.

In the past, advertising companies and users were not accustomed to a direct discussion regarding their preferences. Not every person had the opportunity to express their view regarding advertisements directly to the advertising party. Both parties, target users and advertisers, lacked the electronic means for communicating with one another. Therefore opinions of users regarding advertisements they were served were not usually channeled to advertisers and publishers.

There is, therefore, a need for the present invention, which encompasses a platform allowing Companies to enable user direct interaction with specific advertisements. The platform is a computer software program which enables Companies to insert with an advertisement they publish online, a method which enables the users viewing this advertisement to interact with it. The software also collects the data received in this interaction and processes it and could display it to Companies and users.

The software program can be a widget over part of the advertisement or next to it or somewhere else in a manner in which it is associated with the advertisement. The viewer of the advertisement can interact with the widget at his will for example but not limited to by mouse click, mouse over or by a text message from a mobile device. When he interacts with the widget the computer software enables him to enter input in connection with the advertisement, which the widget is associated with. The software can store the data regarding these interactions and use it. A display system can exist to show the statistical data collected by this software program.

The platform can also collect data regarding these interactions. The platform can enable users to perform various actions of interaction with advertisements including expressing their opinions regarding advertisements directly. Other actions in the platform for engaging with advertisements can include, but is not limited to, sharing advertisements with other users, commenting on advertisements, and more.

This invention intends to enable implementation of the platform in conjunction with advertisements by companies or by users. Companies include media related companies, advertisers, ad networks, ad servers, ad agencies, publishers, digital media, creative agencies, social networks and any other party wishing to implement the platform and have users interact with advertisements. It is also possible potentially for other parties to join the platform and enter advertisements with it. Other potential parties for participating in the platform include internet server providers, mobile operators and publishers, and any other party who is interested in enabling users to interact with advertisements electronically. We will refer to them as “Advertisers” or “Companies”.

### SUMMARY

It is therefore desirable to enable advertisers to maximize user relevancy in the exposure of their online advertisements (reaching qualified users, not random ones). Using such a platform, users can express their feedback directly to advertisers, who thereby receive data about advertisements directly from the users. Since these are the same users that the advertisement is addressed to, this knowledge is valuable to the advertiser.

Thus, this solution provides comprehensive information of the perspective users and their thoughts to the advertising party, be it the publisher or the advertiser. The historical data provided represents the users' true stated preferences, and not assumptions based on previous actions.

It would also be desirable for advertisers to gain direct knowledge of the user who strongly objected to their brand or advertisement. They also are capable of knowing whether, and why, their users have developed strong negative views about their advertisement or product. This would enable them to make educated advertising decisions and increase their advertisements' effectiveness.

Other interactions of the user also provide invaluable information to the advertiser as well as to the users. Examples for this include, but are not limited to the following interactions: rating advertisements; sharing advertisements thereby enabling the users to send advertisements to their peers; tagging or otherwise enabling the users to add information regarding the advertisement with or without the ability to share these “tags” (which can be categories, names) with other users; commenting—enabling users to enter text comments and reactions (these may be longer than the “tags” and serve a different purpose) regarding the advertisement they are interacting with; bookmarking the advertisement so that the user can store the advertisements he wishes to return to; additional interactions with advertisements can be made available to users as well.

The main embodiment of the platform consists of:
1. A client side application which can be embedded with an advertisement, either as part of the advertisement's file itself, and therefore can be interacted with over the advertisement, or as a separate application which recognizes the advertisement (for example by ID) and is associated with this specific advertisement.
2. This client side application is viewed in conjunction with the advertisement and has the interaction capabilities. The interaction capabilities can be directly in the client side application, or uploaded directly from the platform (e.g. via a link or a movie clip in flash for instance)
3. The interaction capabilities described can be in various forms as described. These include, but are not limited to, rating, sharing, sending, tagging, commenting, bookmarking, adding notes or other information, answering multiple choice questions, answering open ended questions. The interaction capabilities can also include several interactions, such as one after another, or have the ability to choose between interactions and interact in several methods.
4. The above client side application transmits to the system the input received by the users' interactions with the advertisement associated with it.
5. The system has memory storage capabilities. This can be on the client side such as computer “cookies”—small data files stored on the computers of the users viewing the advertisement, as well as in the system's centralized location/s stored in various methods such as a database.
6. The system can analyze the data received from the users' interactions in many ways. It can aggregate the raw data of the interactions with advertisements, and break them down by client, by campaign, by advertisement, by geographical location, by the website in which the advertisement has been published.
7. The system can have display capabilities. Displaying to the advertisers and/or to the users the results of the aggregated data of the interactions of the users. This can be displayed by preference—for the advertisers by advertisements and by various breakdowns—for example if the users were asked for their sex, then results can be shown by Male and Female. And for users the results can be shown by ratings—for example showing the highest and lowest rated advertisements for the day.
8. The system will have the ability for Companies to add advertisements to the platform and explanations as to how to embed the interaction application to the advertisement—manually or automatically through the system.
9. The platform described in these steps is the explanation of the main embodiment of the computer software program of the present invention, including the interaction capabilities with the advertisement, and a system which electronically receives the data and can display it. However this is just one alternative for implementing the invention, and should not be limiting. As the invention also can be implemented without the display section, thereby focusing on encouraging user engagement with the advertisement for the sake of enhancing user interaction. Recording and displaying these interactions will only be necessary to prove that the interaction indeed increases the campaign's results in this case.

Other different embodiments for the system are possible as well. Some of them are described in this application. [An example for another alternative embodiment is an advertisement seen on television, which has a widget with instructions for the user to send a text message with his rating/comment.]

It would be desirable to enable online targeting which takes into account the user's direct and willful participation. This targeting is based on users' stated preferences and behavior by rating advertisements and providing additional data such as demographics, locations, and ratings through the invention's platform.

This above targeting would alleviate privacy concerns of users, as the users themselves knowingly disclosed and provided the information which is being made use of in the platform. This is important especially as users become increasingly more aware of their privacy considerations.

Such a proposed method and system would provide for a scope of user feedback that would be very wide and would include every user who decides to participate and interact with the advertisement, thereby providing a sample representative mix of the potential consumers.

An additional advantage of the present invention which could stem from the platform's ability to leverage networks and online communities in order to profit from their large user base, and use them to their strategic advantage.

This present invention would enable users to express their opinions regarding the advertisements directly to the advertisers. Many users are annoyed with existing advertisements. They would be able to utilize the system as a place where they can direct their opinions pertaining to specific advertisements directly to the advertisers.

Additional goals and advantages of the present invention include:

Increasing relevancy of advertisements to users. This is not only due to advertisers' knowledge of users' preferences (see above) but also by other methods of user engagement with the advertisements, such as by advertisements sent to users by their peers, which are specifically relevant to them.

Creating an online community around advertisements which are popular with the users. This would be a place for users to list their preferences relating to specific categories of advertisements which they may be interested in receiving. This through an additional section of the platform which includes a destination website with the users' preferences, bookmarked advertisements, and activity streams regarding online advertisements sharing, ratings, comments and other responses to the advertisements.

Gathering statistical analysis of users' preferences and behavior in relation to online advertisements in general and in relation to specific advertisements.

Providing a method for online publishers and social networks to profit from their large user base through participation in a global third party system for ad-sharing and rating.

Providing detailed feedback data to advertisers as to:
1) General user receptiveness of their advertisements (or dislike of their advertisements).
2) Demographic and other detailed data regarding acceptance of their advertisements or of general industry reactions (including from competitors' advertisements) of specific targeted user base.

Providing additional exposure of users to advertisements (such as the top voted advertisements on the website), in a manner which is viewed more positively and favorably by the users.

The present invention provides a method and a system for users to interact with advertisements electronically. The users interact with specific advertisements they encounter for instance by electronically providing feedback and by sharing the advertisement with other users. Additional potential forms of engagement include discussions, comments, and responses to questions posed by the system, e.g. regarding demographics. The platform collects, processes and stores this data provided by users.

Specifically, in the main embodiment of the present invention users interact electronically with advertisements via the internet. The host website, likely to be provided as part of the platform as a service to Companies, maintains an online database for advertisements and user preferences.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates an advertisement which enables users to interact with it in accordance with the present invention wherein users can click or move a cursor over a widget (a widget is a graphical computer user interface object such as but not limited to a window or text box) in order to interact with the advertisement in accordance with the teachings of the present invention;

FIG. 2 illustrates a “pop up” that opens up when the users interact with the widget of FIG. 1, enabling the users to express their opinion about the advertisement through the “pop up”;

FIG. 3 illustrates another feature of the present invention in which an advertisement enables users to interact with it, as in FIG. 1.wherein a user is able to interact directly with the widget without the additional “pop up” widgets as in FIG. 2;

FIG. 4 illustrates a data report of the present invention that conveys the aggregated information about users which interacted with advertisements via widgets as described in FIGS. 1-2;

FIG. 5 illustrates a “pop up” which opens up when the users interact with the widget from FIG. 1, enabling the users to share advertisements with other users through the “pop up”

FIG. 6 describes an another embodiment of the present invention illustrating a process and a system that records user interactions and returns other relevant advertisements to the user;

FIG. 7 depicts a process of the present invention that allows advertisers, publishers or other parties to include the platform with any advertisement they publish online thereby enabling the users viewing these advertisements to interact with them;

FIG. 8 illustrates a process of the present invention that allows users to include the platform with any advertisement they view online thereby enabling the users viewing these advertisements to interact with any advertisement they encounter online; and

FIG. 9 illustrates a process of the present invention that enables users to interact with the advertisements they encounter online.

### DETAILED DESCRIPTION OF THE PREFERRED EMBODIMENT(S)

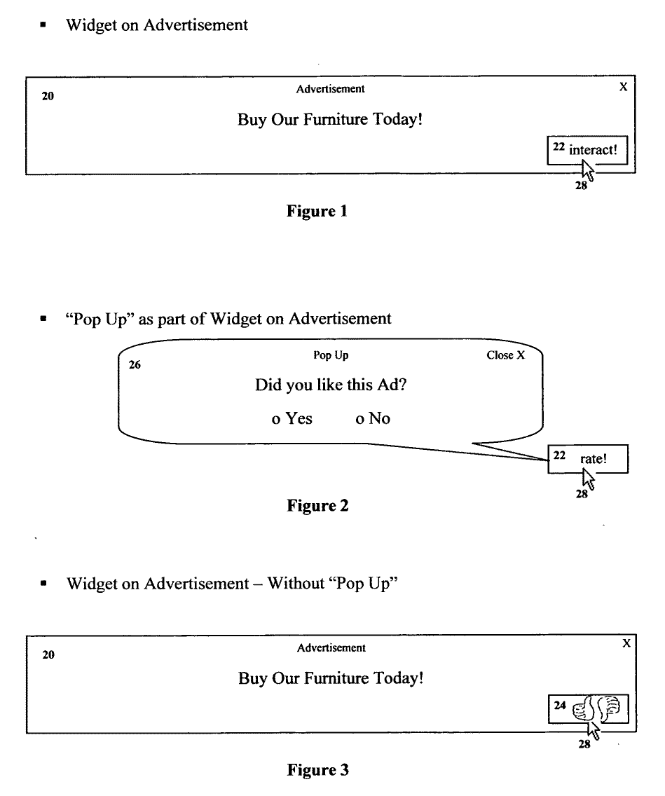

Referring now to the drawings of FIGS. 1-9, FIG. 1 illustrates an advertisement 20 which enables users to interact with it. Users can click or move a cursor such as a computer mouse 28, over a widget 22 which then triggers a “pop up” 26; Instead of “rate”, widget 22 can read “share” thereby triggering “pop up” 34. It can also read something else, according to the action, the widget enables the users to perform with regards to the advertisement. Widget 22 can also look differently than portrayed.

This advertisement 20 with the widget 22 can be shown wherever the advertisement is served.

The advertisements can be different than the one depicted by 20. These include various types of advertisements, for instance ones on a distributed computer network such as the internet, in various graphic designs, and in many technologies and forms including banner ads, flash, picture, text ads, widget, voice, video ads, any other electronic advertisements including on mobile, portable or other devices, in text messages (such as reply to rate), in email communications, or any other promotional content of any kind.

FIG. 2 illustrates a “pop up” 26, which opens up when the users interact with a widget 22 such as a text box with their cursor 28 or via other electronic means (e.g. computer keyboard, touch screen, etc.). In the non-limiting illustrating example the widget or text box 22 has an advertisement that states “Buy Our Furniture Today”. FIG. 2 represents the advertisement after the user has decided to click on or to move their mouse over the widget on the advertisement, and a “pop up” appeared which enables the user to interact with this advertisement, and, in the illustration, specifically to rate it.

The “pop up” could include various methods of interaction, aside for the one illustrated in the drawing. These include Boolean questions, as seen in the drawing, multiple choice and other questions. Note that closing by clicking on the “X Close” button in the “pop up” is not considered as a rating. The widget and or “pop up” can also include a text box for the users to type in data, including their comments or answers to questions; or various scaled rating metrics; e.g., rating stars 1-5, thumbs up or down—see FIG. 3 widget 24. Other potential feedback options not portrayed in the drawing, include feedback forms such as text, or more indirect methods, such as considering the action of closing the advertisement by clicking on the “X” or “Close” button (intended for closing the advertisement) as the negative rating, and clicking on the advertisement (Click Through) or on the portrayed widget to indicate a positive rating. There can be many other methods to rate or interact with the advertisements, some of which are described in the specification.

FIG. 3 illustrates an advertisement 20 which enables users to interact with it, similar to FIG. 1. This embodiment differs from FIG. 1 in that it enables the user to interact directly with the widget 24. (widget: a graphical computer user interface object) It does not require additional “pop up” widgets such as widget 26 (FIG. 2). The interactions occur through the user's actions via the Cursor 28 or other electronic means.

FIG. 1-3 all describe a method and a system for users to interact with advertisements electronically through the system. It provides advertisers and publishers a method for receiving direct information and feedback from the users regarding the advertisements and engaging the users with the advertisements.

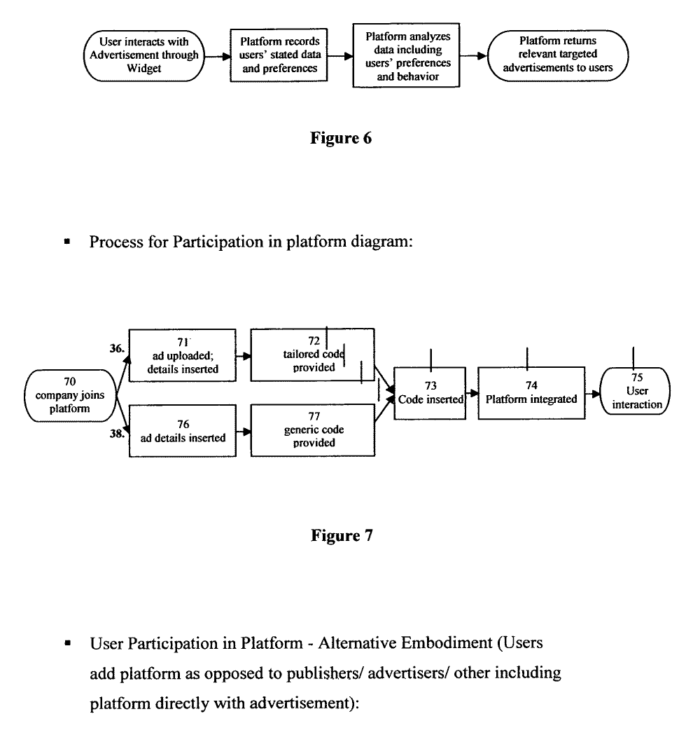

The interaction techniques of the present invention include, but are not limited to:
A. Rating the advertisement. This can be done by providing rating metrics. An example is choosing “Positive” or “Negative”, choosing “Like” or “Dislike” or thumbs up or down 24. Another rating metric includes choosing a number on a scale, such as from 1 to 5, often portrayed as stars. Feedback from users regarding advertisements can also be received by other methods, such as by email, posting/sharing on other websites, text and media messages (sometimes referred to as “SMS”, “MMS”), voice, phone, mobile, other portable device and other methods.
B. Sharing the advertisement. This enables the option of sending the advertisement to other users; see below FIG. 5 and widget 34. This can be done in various electronic destinations and methods. Examples include sending the advertisement to the user's email address, social network inbox, mobile device, messaging system, readers, RSS feeds (Real Simple Syndication, various web feed formats used to publish content), blog (web log), twitter (micro blogging for shorter content—up to 140 characters), and any other address, device, or electronic mailbox or electronic distribution means. There is a potential for partnering with content distribution service providers (such as Gigya) which can take part in the distribution of the shared advertisements. The shared advertisement includes the advertisement published and any links (URLs) associated with it. See FIG. 5 description below.
C. Bookmarking the advertisement. This will enable the user to save links to, and record the location of, preferred, interesting, noteworthy, and any other advertisement the user would potentially like to return to. This can be done in a host website which will aggregate the user's bookmarks, or through email, mobile device or any other electronic means.
D. Eliminate repetition. This enables the user to request that the specified advertisement not be shown again.
E. Repeat advertisement or similar. The users can request to be shown again the same or similar advertisements. These can include related advertisements or other advertisements in the same or a related category. See FIG. 6 description below.
F. Commenting. This feature will enable the users to include their opinions and comments regarding the advertisement. It can be done in various forms. These include short text comments in the “pop up” 26 text box (FIG. 2), as well as longer posts in a host website either on a personal blog page, or on the central page for the specific advertisement.
G. Discussion. This will enable the users to discuss their opinions and thoughts regarding advertisements with other users. This can be done in the “pop up” 26 (FIG. 2) or in the host website.
H. Answering questions. This will enable the user to answer questions regarding themselves or regarding the advertisement. The questions can be multiple choice questions or open ended questions. Some examples are “Are you Male or Female?” “Age group?” “What did you dislike about the advertisement?” “Was it the Product, Advertisement design or content which that influenced your response?” and many other potential questions, including locations, categories of interest, preferences and more. These responses will be recorded and help analyze the results of the users' views regarding advertisements.
I. Choosing Tags or Categories. This will enable the users to add tags (labels, related words, expressions) and/or labels and/or categories to the advertisements. This will enable them to express their opinion in a unique way. It will enable advertisers to receive concise feedback regarding their advertisements, and will label and organize advertisements for users in a unique way.

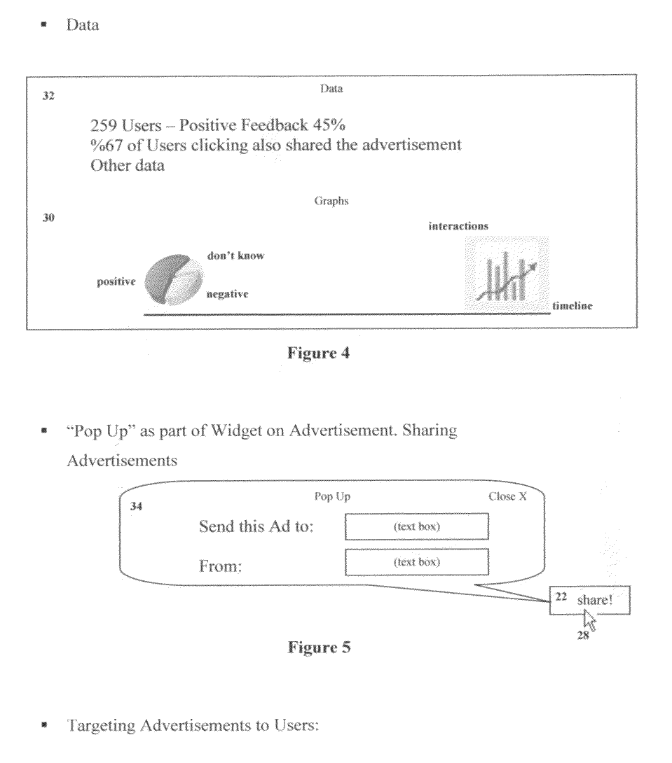

FIG. 4 illustrates the data system portraying the information gathered by the platform. The data 32 collected from the users which interacted with the advertisement, using widgets 22, 24 and “pop up” 26 is presented here. The data 32 and the graphs 30 portray a summary of information aggregated by the system.

There can be many methods of collecting the data and presenting it. It can be done through various database types and storage methods (e.g. MySQL—mysql.com), and various web languages and technologies which are available today and will be developed in the fixture (e.g. PHP, .NET frameworks). Other parts of the platform can also be performed by a variety of technological solutions.

There can be various modes of processing and aggregating the ratings data and the various other data collected by the system. This can be, for example, a simple aggregation of the data, a segmented aggregation according to industry or demographics, or another intelligent sectioning or processing of the data by specific algorithms. The data can be portrayed in charts, in graphs or other physical and graphical display and viewing methods.

FIG. 5 illustrates a “pop up” 34, which opens up when the users interact with widget 22 with their cursor 28. This figure is similar to the second one (FIG. 2), but here the user has decided to share the advertisement with one of their peers.

Using this “pop up”, the users can enter an address (such as e-mail address) to which they would like to send the advertisement 20. They can also enter their own name and/or address. The shared advertisement is then sent by the system to the destination address specified. This process can be automated to remember or recognize the user's address and preferred destinations they send advertisements to.

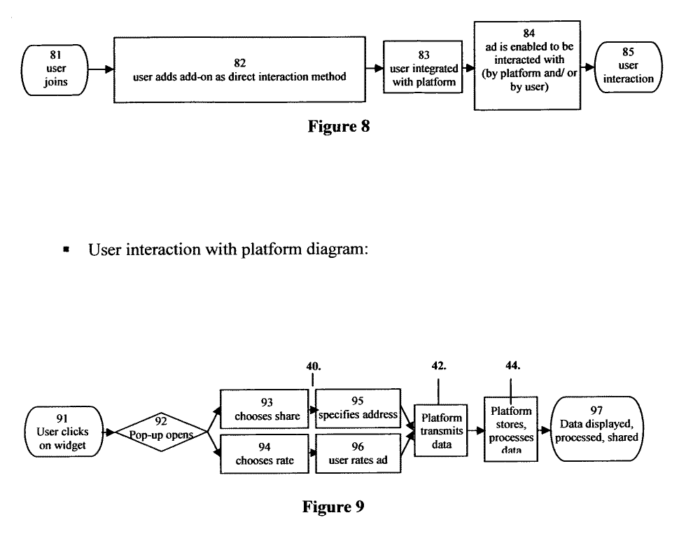

The difference between the different options for widget 22 depends on the party implementing the connection between the advertisement and the platform for interaction. It can either have all options for interacting (e.g. share, rate, comment) or just one of them. Parties implementing the platform can be categorized into two segments: Companies (e.g. advertisers) versus users; see FIGS. 7-8.

FIG. 6 is an additional potential use of the invention. The figure presents a process for better targeting advertisements using the system. Users can specify their favorite advertisements through widgets 22, 24, 26, 34 and similar widgets. The system can then serve more relevant advertisements to these users according to their stated preferences. For instance, they can be served advertisements in the same or similar categories or related advertisements. Thus, the targeting of advertisements can be done based on the users' stated preferences and behavior.

FIGS. 7-8 present two possibilities for implementation of the present invention, in two different manners in which the platform can be coded and operated.

FIG. 7 depicts a process which allows advertisers, publishers or other parties to include the platform with any advertisement they publish online. This thereby enables the users viewing these advertisements to interact with them. Two options are described in the figure for adding a widget (e.g 22, FIGS. 1, 2, 5; and 24, FIG. 3) to an advertisement. The difference between the two options is the method of adding the widget to the advertisement.

One alternative 36 enables to insert an advertisement on which the system will generate a custom tailored code for the specific advertisement. For this process, the company (e.g. advertiser or publisher) joining the system needs to upload their advertisement via the platform's designated place to perform such uploading, such as a digitally supported computer file, and the system adds the widget to it and sends it back. This process can be done manually as well, via email or other means.

The steps in this alternative 36 include: the joining party joins the platform (step 70); once they joined—inserting an advertisement and basic details in association with the advertisement (step 71); the platform providing a tailored code for the specific advertisement (step 72); code inserted in conjunction with or over the advertisement by the company receiving the code (this can also be done by a computer automatically which will combine the code automatically with the system, or manually by a representative from the platform operators) (step 73); in this next step, the ad is already integrated with the platform, including the widget (e.g. icon with the interacting/rating capability, a pop up enabling interaction with the ad), and the platform's connectivity to the memory location/s (e.g. database, “cookie”, host website) storing and processing the interaction data is in place, and is ready to operate once it is published by the advertiser (or other party responsible for publishing the advertisement) (step 74); the platform is operating, users viewing the advertisement can now interact with it, the platform records these interactions, and the data flows to the other parts of the system (step 75).

The other alternative 38 enables to receive generic code from the system for each advertisement. In this case, an advertiser wishing to include an advertisement in the system needs to receive standard code from the system. This code, after it has been inserted in connection with the advertisement, will add the user interaction widget such as widget 22 to the advertisement. This occurs without the advertisement having ever been entered into the system.

The steps in this alternative 38 include: the joining party joins the platform (step 70); when they joined—they sign up but are not required to upload or send the advertisement itself (they may be requested to list it) (step 76); the platform will generate a generic code to be included with the ad (step 77); the rest of the steps are identical to alternative 36.

Parties joining the platform as described in FIG. 7 include advertisers, ad networks, ad servers, ad agencies, publishers, social networks and any other party (see Objects and Advantages section above).

FIG. 8 illustrates an alternative embodiment of the present invention. The figure depicts a process which allows users to include the platform with any advertisement they view online. This thereby enables the users viewing these advertisements to interact with any advertisement they encounter online.

The process enables users to download an add-on to their browser (or other client side application). Using this add-on the system will enable these users to interact with any advertisement they wish to interact with through the system.

The steps in this drawing include: The user joining the platform (step 81); User adds (e.g. downloads and installs) an “add-on”, provided by the platform, to his browser or other direct interaction method (such as in client side), which enables the user to interact with ads (step 82); the platform integrates with the user, once the previous step has been made (step 83).

In this next step, there are two alternatives which are possible: one is that the platform will automatically recognize advertisements viewed by the user and add them to the platform by including the widget (e.g. icon with the interacting/rating capability, a pop up enabling interaction with the ad) with these ads, and have the platform's connectivity to the memory location/s (e.g. database, “cookie”, host website) storing and processing the interaction data is in place, OR the platform will enable the user to recognize advertisements (e.g. by clicking on them in conjunction with the “add-on” and recognizing them as advertisements, submitting them to the platform) and thereby enabling the user to interact with them from the user's “client side”—such as through the user's browser—sending the data to the platform as the other alternative would. These alternatives can also work together, for instance either the platform recognizes the advertisement and enables user interaction with it, or platform is unsuccessful in recognizing the ad, in which case user can identify it directly as such (as an ad) and include it in the platform. The platform is ready to operate for this user (step 84); the platform is operating, the user encountering advertisements can now interact with it, the platform records these interactions, and the data flows to the other parts of the system (step 75).

FIG. 9 describes a process which enables users to interact with the advertisements they encounter in various locations on a distributed network of computers (such as the internet), and not necessarily at the platform's home site (in any location where there is an advertisement which participates in the platform) users can interact with advertisements which participate in the platform (see FIG. 7 on how to have an advertisement included with the platform). It is also possible to have a method in which the users will interact with advertisements they encounter online which are not currently included in the platform. This is done by allowing the users to join the platform themselves and interact with advertisements they encounter online whether or not the advertiser/publisher/website is participating in the platform (See FIG. 8 on how to have users join the platform and include advertisements they encounter with the platform).

FIG. 9 represents an example for interaction of the users with advertisements through the system. Methods users can interact with the system in this illustration include rating and sharing advertisements with other users. There are additional methods available to interact with the advertisements such as commenting and other community features not illustrated here.

The steps comprising FIG. 9 are as follows:

Users viewing an advertisement click or move their mouse over the platform's icon which is included in conjunction with the advertisement (e.g. over it, next to it, or other clear association with the advertisement) (step 91); a pop-up opens (this step is not necessary, as the interaction can occur directly with the widget which is visible in step 91) (step 92); user can choose which interaction they want—here there are two alternatives (together element 40, steps 93-96). In the first alternative (steps 93 and 95), the user chooses to share the advertisement (step 93); and specifies the location or address where the platform should send the ad (step 95); In the second alternative (steps 94 and 96), the user chooses to rate the advertisement (step 94); and does so, the rating can be done in various manners such as text comment, specifying “like” or “dislike” or via other methods (step 96); the platform then transmits the interaction data to the destination requested (if there is a “share advertisement” request, such as to the user's peer's email address) and in any case will transmit the data regarding user interactions with advertisements to the system (step/element 42); the system then stores the interaction data and aggregated interaction results (such as overall ratings), as well as processing any other requests such as breakdowns by various parameters including but not limited to geographical location, website where the advertisement was published, category of the advertisement, and more (step/element 44). See more on elements 40, 42 and 44 below. Finally, the data collected and stored by the platform in the various locations can be used in various ways such as: displayed in a host website, shared with Companies including their advertisements with the platform, used for market research reports, and other usages.

The system can include a receiving element 40 which is the input received by the user which is interacting with the advertisement through the platform, i.e. the user rating the advertisement, receiving positive or negative rating from a user, or, if the user is sharing the advertisement—the element would be receiving a request from the user to send the advertisements to one or more of his peers.

The system has a transmitting element 42, which would send the data and record it on the system, for example for a rating received by the user it will send the data to the database. For a sharing advertisement request by the user to send the advertisement to another user, the system (in addition to sending the data to the database) sends the relevant advertisement to the requested destination location (for example another user) through one of the various online sharing options, such as email or a messaging system or any other sharing method, or, for registered users, through the website's messaging system. The system has a data storage (including recording and processing) element 44, which records the rating or the sharing requests from the users (and any other user interaction with online advertisements through the platform). It stores the data received by the users in the database, any information which flows in the system, including, among others, every action the users performed and every location an advertisement was sent to, and where on the web it was done, and by whom. This element can also include other processing such as algorithms the platform can put in place to analyze the data received by the system. See below for additional possible usages of this data.

The data collected by the system can be used, among other things, for:
A. A destination website which aggregates the data on the whole platform 44, and shows some of it on the website or the system.
Statistical analysis of users' preferences and behavior in relation to online advertisements in general and in relation to specific advertisements can be performed. This analysis would therefore be based on a sample of a large pool of users, and would provide invaluable data to advertisers and publishers. The data can be broken down by many measures including geographical, demographics (e.g. sex, age), campaign, advertisement, banner, views, rating, advertisement sharing, comments by users, website, publisher, advertiser, category, users, users' peers, users' preferences, operating system, browser and other data and breakdowns.
It has the said information including sent items and said ratings, and a totaling element which is an aggregator both for chronological data including all activities, as well as for totaling arranged to total the ratings from a plurality of users regarding the advertisements to generate top (and bottom) advertisements lists for the entire user pool, for the specific user, and for the user's peers or users which the user follows on the system. This may also include other data, which might not be shown on the website, but will be available as research data. For example data regarding ratings of users from a certain geographical area regarding a specific category or industry—for example 75% of responses of 30-45 year old males from the Florida area might give positive ratings to high end automotive advertisements, or a similar result might occur relating to advertisements regarding gadgets in the San Francisco area which are being forwarded at a high rate by users. This may contain user demographics data pertaining to specific advertisements and/or specific advertising categories or industries, regarding the various users' engagement with them and other data which will become available in regards to the users through the platform.
A destination site can include aggregators of all activities as well as the most, and potentially also of the least popular advertisements and other activities done by the community such as sharing of advertisements by other users and such as commenting on advertisements. Such a site can also include generated cumulative rating indicators as collected from aggregation of the ratings and activities of the various users.
B. It will be possible to create a social community focused around interactions with advertisements, such as rating them. Such a website can incorporate users' preferences, bookmarked advertisements, activity streams in regards to online advertisements sharing, rating, as well as other user interactions. The website can also provide an electronic place to send updates regarding friends or followed users' activities, shared ads, and interactions with advertisements. The users can register to receive more advanced features and be remembered by the website. Users can also maintain and update profiles with details about their preferences regarding advertisements or industries, share advertisements on the site, games which include advertisements or more exposure to them, and other features.
This can also be done through establishing a partnership with an existing online community. Such partnerships with online publishers and communities may enable users to send and share these advertisements on their websites, thereby leveraging their networks and potentially enabling profit sharing with these sites. Potential Companies, partners or clientele, include advertisers, publishers, ad networks, ad agencies and other companies may enable to include many advertisements in the system, providing them with valuable data regarding their advertisements and user responses to them.
C. Targeting of advertisements to specific users, as depicted in FIG. 6. This process better targets advertisements, using the system. Users can specify their favorite advertisements and their feedback and other interactions through the system. Then the system can subsequently serve more relevant advertisements to these users according to their stated preferences and previous activity. For instance they can be served advertisements in the same or similar categories or related advertisements to their favorite advertisements. Thus, the targeting of advertisements can be done based on the users' stated preferences and behavior. This can be either specifically for registered users, or for any user interacting with the system. One potential method would be through client based cookies (a small text file placed on the user's computer which can store information regarding the user, their historical data, actions and selections).
D. It also may be possible to reward financially users who share advertisements or to share profits with online networks. This would enable online communities and users are interested in leveraging their network of contacts in order to profit from their large user base.
E. A system which will collect and present the data to clients or partners can be included or omitted from the platform. Other sections may be omitted from the platform. Data displayed on destination website or in the system can vary; it can include or exclude any of the features and methods mentioned.

Thus the present invention provides users with the ability to interact with advertisements electronically (for instance by providing feedback) provides a highly efficient, useful, tool for both advertisers and users. Both sides can then communicate directly and thereby optimize the advertisements served for all, including users on the one hand, and advertisers on the other hand.

While my above description contains many specificities, these should not be construed as limitations on the scope of the invention, but rather as an exemplification of preferred embodiments thereof. Many other variations are possible. For example it is possible to provide electronic means for user interaction with various forms of advertisements, such as video, or full page ones. It is also possible for any shape, design or color of advertisement and any shape, design or color of the widget enabling interaction with the advertisement. It is also possible to include various types of interactions, in addition to rating and sharing advertisements.

While presently preferred embodiments have been described for purposes of the disclosure, it is understood that numerous changes in the methods can be made by those skilled in the art. Such changes are encompassed within the spirit of the invention as defined by the appended claims.

Thus, the scope of the invention should be determined by the appended claims and their legal equivalents, rather than by the examples given and embodiments illustrated.

What is claimed:

1. A method for interacting with an advertisement electronically by a user, the steps comprising:
a. Accessing an advertisement by a user through an input device, said input device including a widget connected with said advertisement for purpose of providing input electronically regarding said advertisement, and inserting reactions (such as additional data) by a user through a keyboard or other electronic method in association with said advertisement and relate to said advertisement by said input device in a manner which is graphically connected directly to the advertisement via a graphical computer user interface object (widget);
b. electronically transmitting the interaction by the user with the advertisement through the widget to a memory of a computer system adapted to receive and store and display the interactions in computer system or a host site that is a part of the computer system wherein the data can be processed, analyzed and displayed to the advertisers of the advertisement and/or to anyone on either the host site or at another location via a software platform of the computer system.

2. The method according to claim 1 wherein said input device permits the user to express feedback.

3. The method according to claim 1 wherein said advertisement is published on a computer based distribution network (such as the internet).

4. The method according to claim 1 wherein said input device permits the user to express feedback in form of scaled rating metrics.

5. The method according to claim 1 wherein said input device permits the user to enter input in text form.

6. The method according to claim 1 wherein said input device permits the user to enter input in form of multiple choice answers.

7. The method according to claim 1 wherein said input device permits the user to send said advertisement to an electronic destination (for example but not limited to an email address).

8. The method according to claim 1 wherein said input means enables human beings to bookmark said advertisement.

9. The method according to claim 1 wherein said input device permits the user to add tags (categories, names) to said advertisement.

10. The method according to claim 1 wherein said advertisement is of display type (banner).

11. The method according to claim 1 wherein said advertisement is of video type.

12. The method according to claim 1 wherein said advertisement is of text type.

13. The method according to claim 1 wherein said input device is through a mobile communication device (such as a cellular phone).

14. The method according to claim 1 wherein said host website aggregates, processes and analyzes data collected from said input device.

15. The method according to claim 14 wherein said host website aggregates, processes and analyzes data comprising means for choosing from a plurality of advertisements as to which advertisement to serve to which user.

16. A system for interacting with an advertisement by one or more user, the steps comprising:
a. an input device for accessing an advertisement by a user through an input device, said input device including a widget connected with said advertisement for purpose of providing input electronically regarding said advertisement so that said user can insert reactions (such as additional data) through a keyboard or other electronic method in association with said advertisement and relate to said advertisement by said input device in a manner which is graphically connected directly to the advertisement via a graphical computer user interface object (widget); and
b. electronically transmitting the interaction of the user with the advertisement to a memory of a computer system adapted to receive and store and display the interactions in a computer system or a host site that is a part of the computer system wherein the data can be processed, analyzed and displayed to the advertisers of the advertisement and/or to anyone on either the host site or at another location by a software platform of the computer system.
